(19) United States
(12) Patent Application Publication
(10) Pub. No.: US 2006/0029694 A1
(43) Pub. Date: Feb. 9, 2006

(54) Feed supplement composition for ruminants and a process to obtain the same

(76) Inventor: Gary Derks, Chesterville (CA)

Correspondence Address: STITES & HARBISON PLLC, 1199 NORTH FAIRFAX STREET, SUITE 900, ALEXANDRIA, VA, 22314, US

(21) Appl. No.: 11/191,265

(22) Filed: Jul. 28, 2005

Related U.S. Application Data
(63) Continuation-in-part of application No. 10/211,312, filed on Aug. 5, 2002, now abandoned.

(51) Int. Cl. A23K 1/22

(52) U.S. Cl. 426/69

(57) ABSTRACT

A process for preparing a feed supplement composition for ruminants, comprising the following steps: (a) heat treating cleaned grains at temperatures ranging from 80° F. to 350° F., for 30 to 120 seconds; (b) transporting the heat treated grains to a vented steeping tank, through a flow control system; (c) combining the heat treated grains with a nitrogenous compound, in the vented steeping tank, using a dosage ranging from 10 kg to 100 kg of nitrogenous compound/tonne of grains; (d) allowing cool air to enter the steeping tank transforming portions of the liquid nitrogenous compound into steam; (e) allowing the steam to flow upwards in the steeping tank; (f) steeping a mass flow of the heat treated grains combined with a mixture of steam and liquid solution of the nitrogenous compound, at a controlled flowrate with an infeed temperature ranging from 100-310° F. and an outfeed temperature ranging from 90-280° F.; (g) allowing the steam to exit the steeping tank; (h) crushing the heat treated grains infused with the nitrogenous compound; (i) cooling the steeped grains combined with the nitrogenous compound, to an outfeed temperature ranging from 180° F. to 190° F., the infeed temperature being higher than the outfeed temperature; (j) optionally spraying the nitrogenous compound, over the heat treated grains, during the cooling step, using a dosage ranging from 10 kg to 100 kg of nitrogenous compound/tonne of grains; and (k) recovering the feed composition. A feed supplement composition for ruminants, obtained through the above described process.

This is a Continuation-in-part of U.S. patent application, Ser. No. 10/211,312 filed Aug. 5, 2002.

### FIELD OF THE INVENTION

The present invention relates to a process to obtain a feed supplement for ruminants.

### BACKGROUND OF THE INVENTION

Animal nutrition is based on four main types of food: a) voluminous food, b) concentrates, c) additives and d) supplements. Grains and grain meals are largely used in feed supplements, specially as energy and protein sources. Among the large variety of grains that are used, soybeans are excellent sources of protein and energy, when incorporated into supplements, feeds and rations.

Known for its high protein content and for its utilization in different kinds of nutrition processes and foods, the use of soybeans in animal nutrition is increasing; however, raw grains cannot be used for ruminant consumption and for monogastric animal nutrition, as the grains have certain compounds called antinutrients, such as the anti-Trypsin factor, an enzyme inhibitor which blocks the action of trypsin, which is an enzyme required for protein digestion; urease (urea degradator); hemaglutinin, an agglutination activating substance that promotes red blood cell agglutination; and phytates, that impede the uptake of essential minerals during digestion.

B. Harris Jr, in “Feeding Raw or Heat-treated Whole Grains to Dairy Cattle”—IFAS/University of Florida, DS28 of March 1990, says that “ruminants animals such as cattle, sheep and goats can utilize grains without being processed. Even so, warnings frequently occur on feed tags, even for dairy animals. The reason for this warning usually involves the use of urea or similar compounds. The urease in raw grains when in contact with urea, destroys the efficient use of urea and releases ammonia, thus, urea should not be added to rations containing ground raw grains”.

These antinutrients are eliminated or at least reduced under thermal treatment, which makes a heat treatment imperative for any kind of ruminant or monogastric animal nutrition, where there is soybean consumption. As described by Belitz and Grosch in Food Chemistry-2nd Edition 1987, highly thermostable inhibitors are present in soybean, such as the Bowman-Birck inhibitor (trypsin inhibitor), and chymotrypsin. There is another proteinase inhibitor, isolated by Kunitz, which is less thermostable. Thus, a correct and proper heat treatment is necessary to ensure safe consumption and to have the best benefit from grain proteins. Different processes of heat treatments are known in the art, such as: roasting, extrusion, micronization, microwaving, boiling and jet explosion.

Teissier, in U.S. Pat. No. 3,937,846, describes a process which involves preparing animal feed compositions comprised of a dry mixture containing 35 to 48 parts of urea with 52 to 65 parts of urea phosphate, melting the urea-urea phosphate mixture at a temperature of 72° C. to 90° C., absorbing the molten mixture in an animal feed material, and cooling the feed material containing the mixture. Teissier also adds a number of other materials to the mixture including at least one basic material, at least one sulfate, nutritional trace elements, vitamins, and molasses. The feed material is also identified as Chinese palm kernel cake. Although the Teissier invention concerns production of animal feed, Teissier's process employs large amounts, or concentrations of urea; the urea-urea phosphate used therein is mixed then melted at temperatures not exceeding 90 degrees Celsius.

Deyoe, in U.S. Pat. No. 4,232,046 discloses a process whereby a substantially non-protein nitrogen (NPN)-free aqueous slurry is formed comprising water and a solids fraction which includes a quantity of an edible, substantially ungelatinized, starch-bearing feed material. The slurry is then directed through a reaction zone and treated at elevated pressures and high temperatures to gelatinize at least a portion of the starch-bearing feed material. Subsequent to this treatment, the slurry can be fortified by addition of an NPN source such as urea to yield a final feed product. The starch-bearing feed material is selected from a group consisting of corn, sorghum, barley, oats, wheat, rice, millet, potatoes, yams, cassava, arrowroot, turnips, rutabagas, corn starch, potato starch, wheat starch, starch-bearing food and beverage processing waste liquors, and mixtures thereof. The Deyoe process need not employ urea as a source of NPN but can use any of a group of NPN bearing substances such as: urea, uric acid, biuret, ethylene urea, ammonia, ammonium salts, propionamide, butyramide, formamide, acetamide, dicyanodiamide, isobutane diurea, creatinine, creatine, lactosyl urea, urea phosphate, fermented ammoniated condensed whey, and mixtures thereof. Also, the starch-bearing feed material that Deyoe uses does not include grains.

Stahel, in U.S. Pat. No. 4,450,176, discloses a process in which soybean material is placed in a closed vessel to which alcohol is added. Agitators in the vessel fluidize the soybean material, and steam is then injected into the vessel and through the soybean material, heating the material. The fluidization of the protein in the presence of heat alters the protein structure for better digestibility and undesirable flavours are removed by the alcohol. Stahel employs only heat in the denaturing process rather than a combination of heat and chemicals, such as urea. Additionally, alcohol is used to remove offensive flavours from the feed material.

Potts, in CA 1,078,663, describes a process consisting of introducing dry feed basal, soapstock and an aqueous solution of 50 to 90% urea into a conditioner, mixing these constituents, conditioning them and then pelletizing the mixture. The order of the mixture is important, as the soapstock must be present in the basal prior to addition of the urea to prevent premature crystallization of the urea. Although the feed basal includes 1.6% dehulled soybean meal, it is also comprised of dehydrated alfalfa, calcium carbonate, gypsum, dicalcium phosphate, sodium chloride, and animal fat.

“Soybean Feeding on the Farm” published by the ‘Ontario Soybean Growers Marketing Board’ as supplement 1993/94 contains considerable information relating to the heat treating and processing of soybeans for animal consumption, and the teachings thereof are incorporated herein by reference. In this supplement, Breuer discusses steeping of soybeans, the process being described by Breuer as allowing the heat of roasted soybeans to equilibrate throughout the soybeans. The steeping as described is carried out at 125° C. to 130° C. for up to 30 minutes after roasting to increase the level of protein resistant to rumen degradation. There is no mention or teaching of steeping grains in the presence of steam and liquid nitrogenous compound.

Various documents of the prior art describe heat-treating soybeans to remove anti-nutritional factors and other enzymes and increase by-pass protein to obtain a better milk, and also describe adding nitrogen or urea to heat-treated soybeans. Steeping the beans is also described as an additional heating treatment and not as a step to increase the moisture of grains entering the steeping tank and consequently increasing the absorption of the nitrogenous compound by the beans.

It is known to use steam for heat-treatments, and it is also known to be used in various other processes by application under high pressure, which consumes a high level of energy and creates a more expensive and dangerous process.

It is then necessary to provide a more economical and safe process for preparing a supplement composition containing grains and a nitrogenous compound.

### SUMMARY OF THE INVENTION

This invention seeks to provide a combination of heat treated grains and a nitrogenous compound, using a safer and more economical process than the previously discussed patents.

As a definition for this invention, grains include any kind of grains and oilseeds.

The invention seeks to provide a process for preparing a feed supplement composition for ruminants, comprising the following steps: (a) heat treating cleaned grains at temperatures ranging from 80° F. to 350° F., for 30 to 120 seconds; (b) transporting the heat treated grains to a vented steeping tank, through a flow control system; (c) combining the heat treated grains with a nitrogenous compound, in the vented steeping tank, using a dosage ranging from 10 kg to 100 kg of nitrogenous compound/tonne of grains; (d) allowing cool air to enter the steeping tank transforming portions of the liquid nitrogenous compound into steam; (e) allowing the steam to flow upwards in the steeping tank; (f) steeping a mass flow of the heat treated grains combined with a mixture of steam and liquid solution of the nitrogenous compound, at a controlled flowrate with an infeed temperature ranging from 100-310° F. and an outfeed temperature ranging from 90-280° F.; (g) allowing the steam to exit the steeping tank; (h) crushing the heat treated grains infused with the nitrogenous compound; (i) cooling the steeped grains combined with the nitrogenous compound, to an outfeed temperature ranging from 180° F. to 190° F., the infeed temperature being higher than the outfeed temperature; (j) optionally spraying the nitrogenous compound, over the heat treated grains, during the cooling step, using a dosage ranging from 10 kg to 100 kg of nitrogenous compound/tonne of grains; and (k) recovering the feed composition.

Preferably, the raw grains are soybeans, and the heat treatment is carried out by flame roasting, dry roasting, extrusion, micronization, microwaving, boiling, jet explosion or a combination of at least two of these processes. The steeping process allows the urea to infuse into the heated grains.

The invention further seeks to provide a feed supplement composition for ruminants, containing:(i) at least one variety of heat treated grains; combined with (ii) a 5 to 40% nitrogenous compound.

### BRIEF DESCRIPTION OF THE DRAWINGS

FIG. 1 shows a preferred apparatus and process for preparing a feed supplement composition.

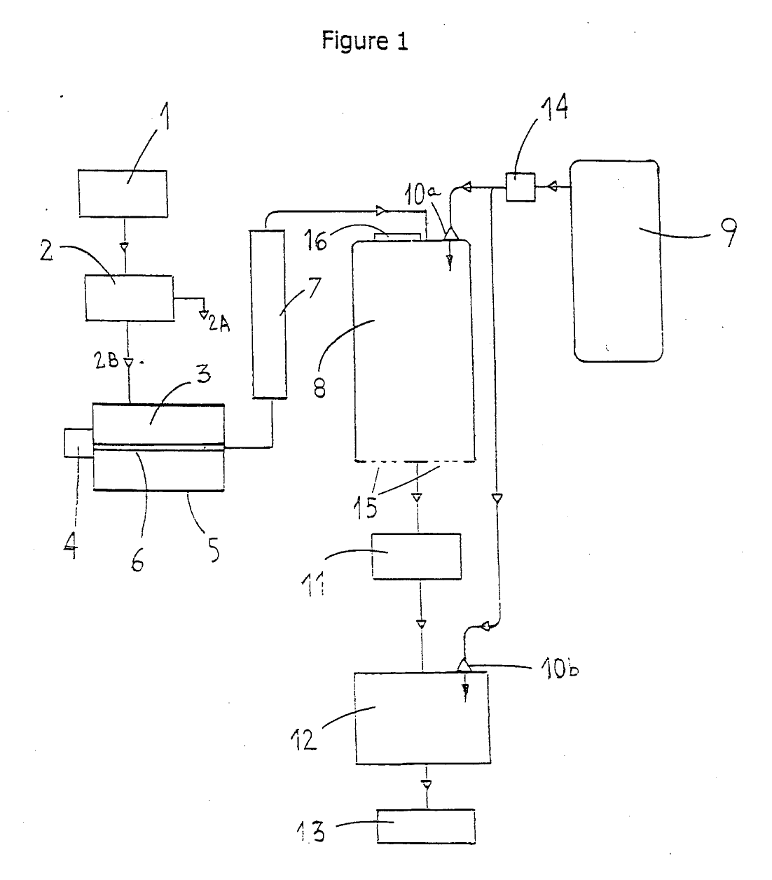

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

As described, the invention involves a process of heating grains. The grains are then mixed with 5% -40% nitrogenous compound. Different nitrogenous commercial products, from various manufacturers, can be used to obtain the desired percentage of nitrogen. Examples of these compounds are an urea-ammonia nitrate aqueous solution containing 28% nitrogen, an urea-ammonia nitrate aqueous solution containing 32% nitrogen, an aqua ammonia aqueous solution containing 20% nitrogen, anhydrous ammonia containing 82% nitrogen and a combination of at least two of these compounds.

The present invention uses heat to treat raw grains, preferably raw soybeans such that the urease enzyme is inactivated. This increases the shelf life of the beans by destroying the lipase enzyme, and increases the soybean bypass protein content, reaching up to 39.04% of bypass in the rumen. Bypass protein is that substance which does not undergo rumen fermentation and is available for absorption in the small intestine thus ultimately providing a larger amount of protein to meet the animal's requirements. A nitrogenous compound, preferably urea and/or ammonia is added to the soybean material to provide a dietary supplement having nitrogen for additional protein production.

With the exception of grains themselves, none of the previously listed feed materials of the prior art, are utilized in the present invention. Also, in the Potts patent the order of mixing of the feed constituents is different from the present invention. The urea concentrations used by Potts are different, and this invention does not require the use of soapstock.

In the present invention the heat treated grains are transported to a vented steeping tank, through a flow control system. During the steeping process the heated grains entering the vented steeping tank undergo a controlled downflow movement and are combined with a nitrogenous compound. The flow of heated grains then comes in contact with the cool air entering through the at least one air intake located at a lower part of the tank. When the heated grains contact the cold air, this gradually transforms portions of the liquid nitrogenous compound into a steamed nitrogeneous compound. The steam flows upwards to exit through the at least one vent located at an upper part of the steeping tank. In the present invention no steam is forced or supplied under pressure into the process, including the steeping step. Rather, the steam is generated and controlled as a consequence of the process management. A much less expensive and safer process is then achieved. By steeping a mass flow of the heat treated grains combined with the mixture of steam and liquid solution of the nitrogenous compound, the grains undergo a higher absorption of the nitrogenous compound, resulting in a more homogeneous content of nitrogen in the grains.

In the process of the present invention it is possible to control the steam generation and flow speed during the steeping process. This is possible by adjusting the aperture of the vents and consequently adjusting the cold air intake. By opening or restricting the vents it is possible to control the cold air intake and consequently the steam generation and flow speed. This is-particularly important for the efficiency of the process due to the differences inherent to grains in terms of their composition, contents, humidity, etc. As different grains need different flow speeds-and different quantities of steam, through these adjustments it is possible to carry out the steeping process under the best conditions in terms of time and steam concentration for the contacting step, allowing a better and more uniform penetration of the nitrogeneous compound into the grains.

The soybean based feed supplement of the present invention fits well with a high corn silage ration to provide a complete high protein cattle feed.

In a preferred apparatus, stored raw soybeans (1), are fed into a cleaner (2) for screening. The debris is separated leaving in line (2A), and the cleaned soybeans leaving in line (2B) are then transported to a flame rotary roaster (3) for heat treatment. The roaster includes a burner (4), a rotary drum (5) and a flame (6), projected from the burner (4). Afterwards, the heat treated soybeans are transported through a flow control system shown as an elevator leg (7), to a vented mass flow steeping tank (8) where a nitrogenous solution, from a solution tank (9) with a flow control system (14), is sprayed onto the heat treated soybeans, using a sprayer (10a) as they enter the tank (8). Typically the beans have a temperature of 290° F. at the top of the tank and an outfeed temperature of 230° F., and an average residence time of about 35 minutes. Typically, 55 kg of solution is used per tonne of grains. In the steeping tank cool air is allowed to enter the air intakes (15) at a lower part of the steeping tank and exit at the vents (16) at an upper part of the tank, transforming portions of the liquid nitrogenous compound into steam, thereby steeping in the steeping tank (8) the mass flow of the heat treated grains combined with a mixture of steam and liquid solution of the nitrogenous compound. The heat treated beans infused with the nitrogenous solution are then moved through a crusher (11), and then moved to a cooling drum (12) where a cooling process with an outfeed temperature of 180° F. takes place and where the nitrogenous solution from the solution tank (9) with the flow control system (14), is optionally sprayed once again, using a sprayer (10b) over the heat treated and crushed grains. The feed composition is recovered in the final station (13). In the crusher (11) the heat treated grains are at least partially broken up, so that they are at least fractured, a proportion of them are broken down into flakes.

In a preferred embodiment for the process for preparing a feed supplement composition for ruminants of the present invention, comprises the following steps:

(a) feeding whole soybeans into a cleaner (2) for screening, and recovering cleaned soybeans;

(b) roasting whole soybeans from step (a) to a temperature of about 180° F. to 350° F., for 30 to 120 seconds, in a flame rotary roaster (5) comprising:

(i) a burner (4);

(ii) a rotary drum (5); and

(iii) a flame (6) inside the drum.

(c) transporting the heat treated whole soybeans to a vented mass flow steeping tank (8), through a leg (7);

(d) spraying the roasted beans with 55 kg/tonne of beans of a urea-based aqueous nitrogen solution, containing 28% nitrogen consisting of: 31% urea, 39% ammonium nitrate, and 30% water, from a solution tank with a flow control system, with an infeed temperature of about 290° F. and an outfeed temperature of about 230° F., for an average residence time of about 35 minutes;

(e) allowing cool air to enter the tank through the air intakes (15) at a lower part of the steeping tank transforming portions of the liquid nitrogenous compound into steam;

(f) allowing the steam to flow upwards, steeping in the steeping tank (8) the mass flow of the heat treated grains combined with a mixture of steam and liquid solution of the nitrogenous compound;

(g) allowing the steam to exit the tank through vents (16) located at an upper part of the steeping tank;

(h) crushing the heat treated beans infused with the aqueous nitrogen solution, in a crusher (11);

(i) cooling the heat treated and crushed beans infused with the aqueous nitrogen solution in a cooling drum (12), to an outfeed temperature of about 180° F.; and

(j) optionally spraying the 28% urea-based nitrogenous solution, from the solution tank (9), using the flow control system (14), into the cooling drum, over the heat treated and crushed beans, using a dosage of 55 kg of nitrogen solution/tonne of beans; and

(k) recovering the feed supplement composition in the final station (13).

Laboratory analysis presented very good results for the feed composition. Results obtained on the feed supplement on an “as is” basis, are presented below:

| Content | Sample 1 | Sample 2 |
|---|---|---|
| Moisture % | 6.84 | 4.75 |
| Protein % (N × 6.25) | 45.74 | 44.92 |
| Calcium % | 0.22 | 0.19 |
| Phosphorus % | 0.58 | 0.59 |
| Sodium % | 0.02 | 0.02 |
| Potassium % | 1.83 | 1.93 |
| Magnesium % | 0.25 | 0.24 |
| Zinc (ppm) | 45.92 | 40.46 |
| Manganese (ppm) | 19.08 | 17.98 |
| Copper (ppm) | 14.14 | 11.95 |
| Acid Detergent Fibre % | 15 | 10.1 |
| Undegraded Intake Protein % | 49.41 | 37.81 |
| of Crude Protein (bypass) | | |
| Degraded Intake Protein % | 50.59 | 49.09 |
| of Crude Protein | | |

In the above description a continuous flow process is described. This process can also be carried out as a batchwise operation. Those skilled in the art of roasting soybeans will realize that the beans will only need cleaning if they are as harvested by the combine. It is not essential that the beans be cleaned as a preliminary to the roasting step, if such cleaning was done prior to storage of the raw beans.

1. A process for preparing a feed supplement composition for ruminants, comprising the following steps:
(a) heat treating cleaned grains at temperatures ranging from 180° F. to 350° F., for 30 to 120 seconds;
(b) transporting the heat treated grains to a vented steeping tank, through a flow control system;
(c) combining the heat treated grains with a nitrogenous compound, in the vented steeping tank, using a dosage ranging from 10 kg to 100 kg of nitrogenous compound/tonne of grains;
(d) allowing cool air to enter the steeping tank transforming portions of the liquid nitrogenous compound into steam;
(e) allowing the steam to flow upwards in the steeping tank;
(f) steeping a mass flow of the heat treated grains combined with a mixture of steam and liquid solution of the nitrogenous compound, at a controlled flowrate with an infeed temperature ranging from 100-310° F. and an outfeed temperature ranging from 90-280° F.;
(g) allowing the steam to exit the steeping tank;
(h) crushing the heat treated grains infused with the nitrogenous compound;
(i) cooling the steeped grains combined with the nitrogenous compound, to an outfeed temperature ranging from 180° F. to 190° F., the infeed temperature being higher than the outfeed temperature;
(j) optionally spraying the nitrogenous compound, over the heat treated grains, during the cooling step, using a dosage ranging from 10 kg to 100 kg of nitrogenous compound/tonne of grains; and
(k) recovering the feed composition.

2. A process for preparing the feed supplement composition for ruminants according to claim 1, wherein the grains are soybeans.

3. A process for preparing the feed supplement composition for ruminants, according to claim 1, wherein the heat treatment process is selected from the group consisting of flame roasting, dry roasting, extrusion, micronization, microwaving, boiling, jet explosion and a combination of at least two of these processes.

4. A process for preparing the feed supplement composition for ruminants, according to claim 3, wherein the heat treatment process is extrusion.

5. A process for preparing the feed supplement composition for ruminants, according to claim 3, wherein the heat treatment process is flame roasting.

6. A process for preparing the feed supplement composition for ruminants, according to claim 1, wherein the steeping of the heat treated grains is performed by spraying a nitrogenous compound, from a compound tank with a flow control system, into the steeping tank, over the heat treated grains, for an average residence time of about 35 minutes.

7. A process for preparing the feed supplement composition for ruminants, according to claim 1, wherein the nitrogenous compound is selected from the group consisting of urea, ammonia and a combination of urea and ammonia.

8. A process for preparing the feed supplement composition for ruminants, according to claim 1, wherein the nitrogenous compound is selected from the group consisting of urea-ammonia nitrate, aqua ammonia, anhydrous ammonia and a combination of at least two of these compounds.

9. A feed supplement composition for ruminants, obtained from the above claimed process, containing:
(i) at least one variety of heat treated grains; combined with
(ii) a 5 to 40% nitrogenous compound.

10. A feed supplement composition for ruminants, according to claim 9, wherein the grains are-grains of equal protein and oil content.

11. A feed supplement composition for ruminants, according to claim 9, wherein the grains are grains of different protein and oil content.

12. A feed supplement composition for ruminants, according to claim 9, wherein the nitrogenous compound is selected from the group consisting of urea, ammonia and a combination of urea and ammonia.

13. A feed supplement composition for ruminants, according to claim 9, wherein the nitrogenous compound is selected from the group consisting of urea-ammonia nitrate, aqua ammonia, anhydrous ammonia and a combination of at least two of these compounds.

14. A feed supplement composition for ruminants, according to claim 9, wherein the nitrogenous compound is selected from the group consisting of 28% nitrogen urea-ammonia nitrate aqueous solution, 32% nitrogen urea-ammonia nitrate aqueous solution, 20% nitrogen aqua ammonia aqueous solution, 82% nitrogen ammonia and a combination of at least two of these compounds.

15. A soybean based feed supplement for ruminants comprising roasted soybeans infused with a nitrogenous solution during roasting and steeping of the grains.
